(19) United States
(12) Patent Application Publication
(10) Pub. No.: US 2026/0191178 A1
(43) Pub. Date: Jul. 9, 2026

(54) SPINNING REEL AND ROD FOR FISHING

(71) Applicant: GLOBERIDE, Inc., Higashikurume-shi, Tokyo (JP)

(72) Inventors: Kazuyuki MATSUDA, Higashikurume-shi (JP); Ryou NAGAI, Higashikurume-shi (JP); Yusuke HIROTA, Higashikurume-shi (JP); Toshiya FUJIMOTO, Higashikurume-shi (JP); Kyohei DAIRA, Higashikurume-shi (JP)

(73) Assignee: GLOBERIDE, Inc., Higashikurume-shi, Tokyo (JP)

(21) Appl. No.: 18/863,688

(22) PCT Filed: Jun. 15, 2023
(86) PCT No.: PCT/JP2023/022268

§ 371 Date: Nov. 7, 2024

(30) Foreign Application Priority Data
Oct. 28, 2022 (JP) 2022-173050

(51) Int. Cl. A01K 89/01

(52) U.S. Cl. CPC A01K 89/011223; A01K 89/0111

(57) ABSTRACT

A fishing rod includes a fishing spinning reel which prevents uplift of the pinion gear and reduces backlash by pushing down the pinion gear in an axially lower direction thereof in any state before and during the yarn winding operation, and after stopping the yarn winding, and a fishing rod including the fishing spinning reel. The fishing spinning reel includes an operating part; reel main body; a drive shaft on the front reel body via a roller bearing and is rotated in conjunction with the operating part; a rotor attached to the drive shaft and rotates together with the drive shaft; and a spool around which a fishing line is wound by rotation of the operating part, in which a pinion gear is provided on the drive shaft, and an elastic member is provided on a front side of the pinion gear in an axial direction of the drive shaft.

### TECHNICAL FIELD

### CROSS REFERENCE

The present application claims priority based on Japanese Patent Application No. 2022-173050 (filed on Oct. 28, 2022), the contents of which are incorporated herein by reference in their entirety.

The present invention relates to a fishing spinning reel that rotates a rotor by rotating a handle and winds a fishing line around a spool through a fishing line guide portion provided in the rotor, and a fishing rod comprising the same.

### BACKGROUND ART

In the related art, a fishing spinning reel is attached and fixed to a fishing rod via a rod attachment portion formed at an end portion of a leg portion extending from a reel main body. The reel main body rotatably supports a handle shaft to which the handle is fixed. In addition, a drive gear is fixed to the handle shaft, and a tooth portion formed on an outer periphery of a base end portion of a drive shaft extending in a direction orthogonal to the handle shaft and rotatably supported by the reel main body meshes with the drive gear. The drive shaft is supported via a roller bearing that restricts axial movement, a rotor is integrally attached to a distal end portion, and a spool shaft extending in a direction orthogonal to the handle shaft passes through the drive shaft. In addition, a spool around which a fishing line is wound is attached to the distal end portion of the spool shaft. The spool shaft reciprocates along a direction orthogonal to the handle shaft by a spool reciprocating mechanism (oscillating mechanism) that converts rotational force from the handle into forward and rearward movement of the spool shaft.

As described above, the fishing spinning reel is configured to rotate the handle to allow the spool shaft to perform forward and rearward movement while rotating the rotor, and is configured to wind the fishing line around the spool via the fishing line guide portion of the rotor. Therefore, a load is applied to the drive shaft from the fishing line wound around the spool via the rotor during a winding operation. Normally, the roller bearing rotatably supporting the drive shaft is configured such that the outer ring is fixed to the reel main body via a fixing member, the inner ring is sandwiched between the drive shaft and the rotor to restrict the axial movement of the drive shaft, and the rotor is fixed to the drive shaft to support the rotor at a predetermined position.

As such a fishing spinning reel, for example, Patent Literature 1 discloses a spinning reel attached to a fishing rod, the spinning reel including: a reel main body having a handle and being attachable to the fishing rod; a rotor that is rotated by the handle and has a cylindrical portion rotatably supported on a front portion of the reel main body, a first arm portion and a second arm portion that are arranged to face each other on sides of the cylindrical portion with a rotation axis interposed therebetween and are integrally molded with the cylindrical portion, a first bail support member attached to a distal end of the first arm portion and having a yarn guide portion at a distal end, a second bail support member attached to a distal end of the second arm portion, and a bail provided from the first bail support member to the second bail support member; and a spool arranged between the first arm portion and the second arm portion, in which a distance from the rotation axis of the rotor to the center of gravity of the second bail support member is longer than a distance from the rotation axis of the rotor to the center of gravity of the first bail support member including the yarn guide portion.

### CITATION LIST

### Patent Literature

Patent Literature 1: JP H7-246045 A

### SUMMARY OF INVENTION

### Technical Problem

When a pinion gear tooth surface and a drive gear tooth surface come into contact with each other in a yarn winding forward direction, the pinion gear receives a force in the reverse direction, and thus, even in a case where there is a rattle in a pinion axis direction, the pinion gear is pressed in a pushing-down direction. However, in a case where the input in a yarn winding direction is discontinuous or the yarn winding is stopped, a force for pushing down the pinion gear does not work, which causes uplift of the pinion gear accordingly. This movement amount is transmitted to the winding side through the handle as a backlash rattle, which causes a problem that an operator feels uncomfortable. On the other hand, in a case where the washer is tightened in a pinion gear axial direction to eliminate the rattle in order to reduce the rattle caused by such backlash, the rotation during the yarn winding becomes heavy, and there is also a problem that smooth rotation is impaired.

The present invention has been made in view of the above circumstances, and an object of the present invention is to provide a fishing spinning reel capable of preventing uplift of the pinion gear and reducing occurrence of backlash by pushing down the pinion gear in an axially lower direction thereof in any state before the yarn winding, during the yarn winding operation, and after stopping the yarn winding, and a fishing rod comprising the fishing spinning reel. Other objects of the present invention will become apparent upon reference to the entirety of the present specification.

### Solution to Problem

A fishing spinning reel according to an embodiment of the present invention comprises an operating part; a reel main body; a drive shaft that is rotatably supported on a front portion of the reel main body via a roller bearing and is rotated in conjunction with the operating part; a rotor that is attached to the drive shaft and is rotated together with the drive shaft; and a spool around which a fishing line is wound by rotation of the operating part, in which a pinion gear is provided on the drive shaft, and an elastic member is provided on a front side of the pinion gear in an axial direction of the drive shaft. In addition, in the fishing spinning reel according an embodiment of the present invention, a rear side of an outer ring of the roller bearing as viewed in the axial direction of the drive shaft is not in contact with the reel main body.

In the fishing spinning reel according to an embodiment of the present invention, the roller bearing restricts an axial movement of the pinion gear and the drive shaft to a front side, the elastic member is provided between the roller bearing and a washer, an outer ring of the roller bearing is attached to the reel main body, and a rear side of the outer ring of the roller bearing as viewed in the axial direction of the drive shaft is not in contact with the reel main body. In addition, in the fishing spinning reel according to an embodiment of the present invention, the roller bearing restricts an axial movement of the pinion gear and the drive shaft to a front side, the elastic member is provided between an outer ring of a unidirectional clutch and a washer, an outer ring of the roller bearing is attached to the reel main body, and a rear side of the outer ring of the roller bearing as viewed in the axial direction of the drive shaft is not in contact with the reel main body. In addition, in the fishing spinning reel according an embodiment of the present invention, the roller bearing restricts an axial movement of the pinion gear and the drive shaft to a front side, the elastic member is provided between a unidirectional clutch and a second holding plate, an outer ring of the roller bearing is attached to the reel main body, and a rear side of the outer ring of the roller bearing as viewed in the axial direction of the drive shaft is not in contact with the reel main body.

In the fishing spinning reel according to an embodiment of the present invention, the roller bearing restricts an axial movement of the pinion gear and the drive shaft to a front side, a unidirectional clutch is provided to the reel main body via a second holding plate, an outer ring of the unidirectional clutch is connected to an outer ring of the roller bearing via a washer, and an elastic member is provided between the roller bearing and the washer, between the outer ring of the unidirectional clutch and the washer, or between the unidirectional clutch and the second holding plate.

In the fishing spinning reel according to an embodiment of the present invention, the elastic member biases an outer ring of the roller bearing to a rear side in the axial direction of the drive shaft.

In the fishing spinning reel according to an embodiment of the present invention, the elastic member is any of a wave washer, a spring washer, a disc spring washer, or an O-ring.

A fishing rod according to an embodiment of the present invention comprises the fishing spinning reel according to any one of above-description; and a rod body.

### Advantageous Effects of Invention

According to the above-described embodiment, it is possible to provide a fishing rod comprising a fishing spinning reel capable of preventing uplift of the pinion gear and reducing occurrence of backlash by pushing down the pinion gear in an axially lower direction thereof in any state before the yarn winding, during the yarn winding operation, and after stopping the yarn winding, and a fishing rod comprising the fishing spinning reel.

### BRIEF DESCRIPTION OF DRAWINGS

FIG. 1 is a view illustrating a fishing rod according to an embodiment of the present invention.

FIG. 2 is a view illustrating a fishing spinning reel according to an embodiment of the present invention.

FIG. 3 is a partially enlarged view of a fishing spinning reel according to an embodiment of the present invention.

FIG. 4 is a further enlarged view of a part of a fishing spinning reel according to an embodiment of the present invention.

FIG. 5 is a partially enlarged view of a fishing spinning reel according to an embodiment of the present invention.

FIG. 6 is a partially enlarged view of a fishing spinning reel according to an embodiment of the present invention.

FIG. 7 illustrates an example of an elastic member of a fishing spinning reel according to an embodiment of the present invention.

### DESCRIPTION OF EMBODIMENTS

Hereinafter, embodiments of a fishing spinning reel and a fishing rod according to the present invention will be specifically described with reference to the accompanying drawings. Components that are common in a plurality of drawings are denoted by the same reference signs throughout the plurality of drawings. It should be noted that each drawing is not necessarily drawn to an accurate scale for the convenience of description.

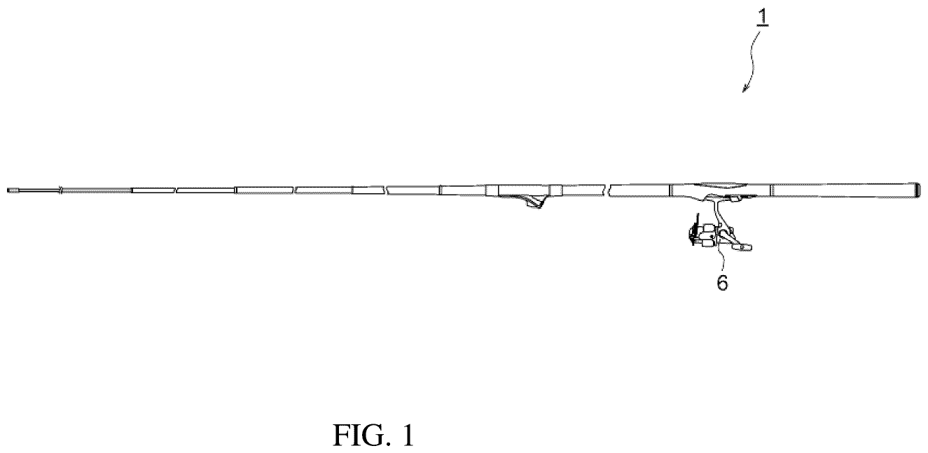

FIG. 1 is a view illustrating an embodiment of a fishing rod according to the present invention. As illustrated, a fishing rod 1 according to an embodiment of the present invention comprises a fishing spinning reel 6 described later.

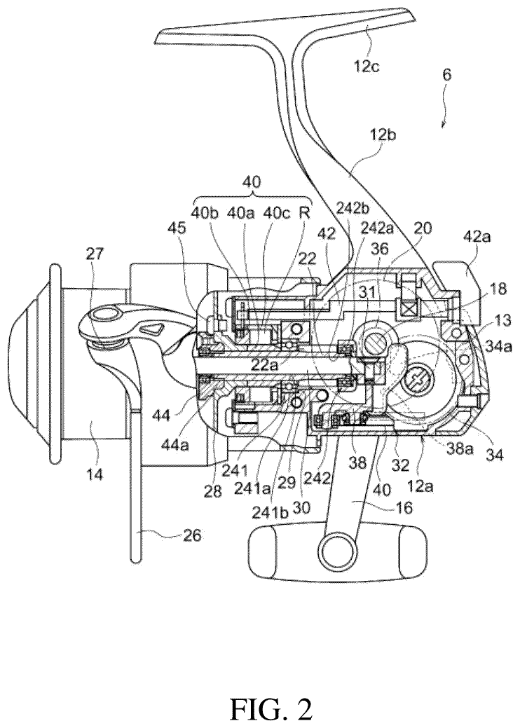

Next, a basic configuration of the fishing spinning reel 6 according to the present invention will be described with reference to FIGS. 2 to 4.

The fishing spinning reel according to an embodiment of the present invention comprises a reel main body 12a, a leg portion 12b extending from the reel main body 12a, and a rod attachment portion 12c formed at an end portion of the leg portion 12b and attached to a fishing rod. A winding drive mechanism for winding a fishing line around a spool 14 is provided in the reel main body 12a. Specifically, a handle shaft 18 to which a handle 16 is fixed is rotatably supported in the reel main body 12a. A drive gear 20 is fixed to the handle shaft 18, and a pinion gear 22a meshes with the drive gear 20.

The pinion gear 22a is provided on a drive shaft 22 that extends in a direction orthogonal to the handle shaft 18 and is rotatably supported on the reel main body 12a via bearings 241 and 242 described later. A rotor 28 comprising a bail 26 and a fishing line guide portion 27 is integrally attached to a distal end portion of the drive shaft (drive cylindrical shaft) 22.

A spool shaft 30 extending in a direction orthogonal to the handle shaft 18 penetrates the drive shaft 22. The spool shaft 30 is disposed concentrically with the drive shaft 22, and can allow the drive shaft 22 to perform forward and rearward movement along a direction orthogonal to the handle shaft 18. The above-described spool 14 around which the fishing line is wound is attached to a distal end portion of the spool shaft 30.

In addition, the handle shaft 18 is provided with a gear 36 that meshes with an interlocking gear 34 of an oscillating mechanism (reciprocating mechanism) 32. The oscillating mechanism 32 of the present embodiment is a so-called gear-type mechanism, and comprises the interlocking gear 34 that meshes with the gear 36 and rotates in conjunction therewith, an engagement protrusion 34a protruding from the interlocking gear 34 and positioned eccentrically from a rotation center axis of the interlocking gear 34, a slider 38 having a cam groove 38a attached to a rear end portion of the spool shaft 30 via a screw 31 and engaged with the engagement protrusion 34a, and a guide rail 40 that is engaged with the slider 38 and guides reciprocation of the slider 38. In such an oscillating mechanism 32, in a case where the handle shaft 18 is rotated by a rotational operation of the handle 16, the interlocking gear 34 meshing with the gear 36 on the handle shaft 18 is rotated, and accordingly, the engagement protrusion 34a of the interlocking gear 34 is rotated, and the slider 38 reciprocates forward and rearward by the guide of the cam groove 38a engaged with the engagement protrusion 34a. Therefore, the spool shaft 30 attached to the slider 38 is driven to reciprocate (to perform forward and rearward movement) along the axial direction.

In a case where the operating part (handle) 16 is rotationally operated to rotate the handle shaft 18, the spool 14 attached to the spool shaft 30 reciprocates forward and rearward via the oscillating mechanism 32, and the rotor 28 is rotationally driven via the drive gear 20, the pinion gear 22a, and the drive shaft 22. In this manner, the fishing line is evenly wound around the spool 14 via the fishing line guide portion 27.

In addition, an end portion of a switching rod 42 of a reverse rotation prevention mechanism including a known unidirectional clutch 40 that prevents reverse rotation (rotation in a fishing line unwinding direction) of the rotor 28 passes through a rear end wall portion 13 of the reel main body 12a, and a switching lever 42a is attached to an end portion of the switching rod 42 protruding to the outside from the rear end wall portion 13. Through the switching lever 42a, the rotor 28 can be switched between a state in which forward rotation and reverse rotation can be performed and a state in which forward rotation can be performed and reverse rotation cannot be performed. In addition, the unidirectional clutch 40 comprises an inner ring 40a fitted to the drive shaft 22 in a detent manner, a retainer 40b that is disposed outside the inner ring 40a and holds a plurality of rolling members R, and an outer ring 40c disposed outside the retainer 40b.

For example, the rotor 28 is sandwiched and fixed between a hexagonal nut 44 screwed to the distal end of the drive shaft 22 and the inner ring 40a of the unidirectional clutch 40. A female screw 44a is formed on the inner peripheral surface of the shaft portion of the hexagonal nut 44, and the hexagonal nut 44 is fastened to the drive shaft 22 by screwing the female screw 44a with a male screw formed on the outer peripheral surface of the distal end portion of the drive shaft 22. The outer peripheral surface of the head portion of the hexagonal nut 44 is engaged with the head portion of a screw member 45 screwed to the rotor 28, and the rotation of the hexagonal nut 44 is prevented by the screw member 45.

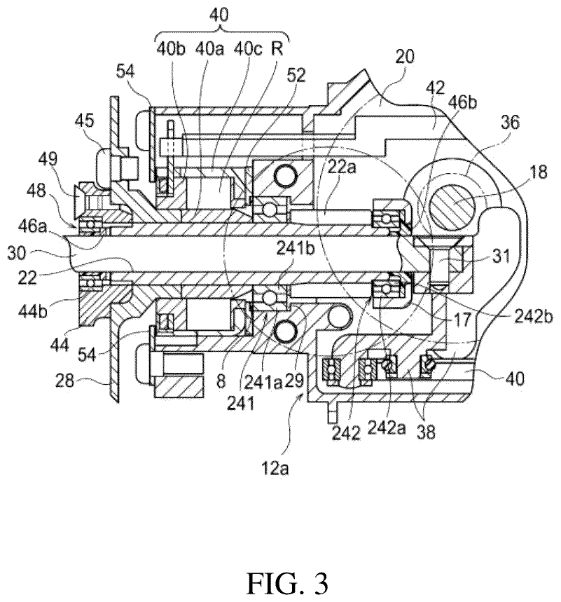

In addition, as illustrated in FIG. 3, a recessed annular accommodation groove 44b is formed on the inner peripheral side of the head portion of the hexagonal nut 44. A roller bearing 48 that rotatably supports the spool shaft 30 via a resin collar 46a is accommodated in the accommodation groove 44b. In the present embodiment, in order to prevent the roller bearing 48 from coming out of the accommodation groove 44b, a flat head screw 49 is screwed to the end surface of the hexagonal nut 44, and the roller bearing 48 is locked via the head portion of this flat head screw 49. Note that, in the rear portion of the drive shaft 22, the spool shaft 30 is supported by the drive shaft 22 and the reel main body 12a via a resin collar 46b, and an extremely small gap S is formed between the inner peripheral surface of the drive shaft 22 and the outer peripheral surface of the spool shaft 30 by the two resin collars 46a and 46b disposed in front of and behind the drive shaft 22. As a result, friction between the drive shaft 22 and the spool shaft 30 is reduced, and the drive shaft 22 and the rotor 28 are smoothly and integrally rotated in conjunction with the rotation of the handle 16.

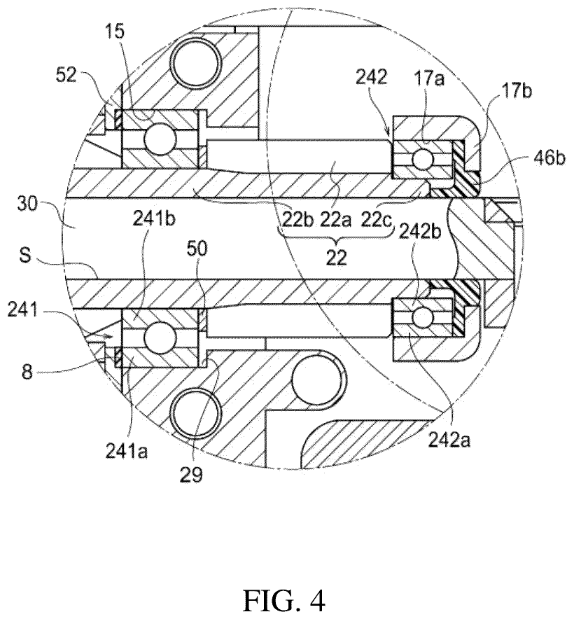

In addition, as illustrated in FIGS. 3 and 4, the drive shaft 22 is supported by the front portion of the reel main body 12a in a state where the axial movement is restricted, by a first roller bearing 241 and a second roller bearing 242.

More specifically, in the drive shaft 22 (also referred to as a drive cylindrical shaft, but referred to as a drive shaft throughout the present specification), the outer diameter of the pinion gear 22a is formed to be larger than those of a cylinder portion 22b and a rear end support portion 22c, and the first roller bearing 241 fitted to an accommodation recess 15 of a stepped structure formed in the reel main body 12a and prevented from moving rearward supports the cylinder portion 22b on the front side of the pinion gear 22a with a washer 50 interposed between the first roller bearing 241 and the pinion gear 22a. On the front side of the first roller bearing 241 (a side opposite to a side where the second roller bearing 242 is present), that is, on the rod tip side, a second holding plate 54 holding the unidirectional clutch 40 in the reel main body 12a is fixed to the reel main body 12a with a fixing screw. As a result, the movement of the first roller bearing 241 to the front side and the rear side is prevented, and the axial movement of the drive shaft 22 to the front side is restricted by the first roller bearing 241 engaged via the pinion gear 22a and the washer 50. Note that, in the present embodiment, in order to engage the washer 50 interposed between the first roller bearing 241 and the pinion gear 22a with an inner ring 241b of the first roller bearing 241 to hold the first roller bearing 241 in the reel main body 12a, a first holding plate 52 interposed between the first roller bearing 241 and the outer ring 40c of the unidirectional clutch 40 is engaged with an outer ring 241a of the first roller bearing 241. However, this may be reversed. Note that a washer can be used in place of the first holding plate 52, but the present specification will be described on the assumption that the first holding plate 52 is used. In the fishing spinning reel 6 according to an embodiment of the present invention, a gap 29 is provided on the rear side of the outer ring 241a of the first roller bearing 241 (on the side of the second roller bearing 242) as viewed in the axial direction of the drive shaft 22, and the rear side of the outer ring 241a of the first roller bearing 241 is configured not to be in contact with the reel main body 12a. Furthermore, the elastic member, which will be described in detail later, is provided, for example, between the first holding plate 52 and the outer ring 241a of the first roller bearing 241. As another aspect, the elastic member may be provided between the outer ring 40c of the unidirectional clutch 40 and the first holding plate 52 and between the unidirectional clutch 40 and the second holding plate 54. Details of each aspect will be described later.

In addition, the second roller bearing 242 that supports the rear end support portion 22c of the drive shaft 22 is accommodated in a support portion 17 formed integrally with the reel main body 12a. The support portion 17 has a recess 17a into which an outer ring 242a of the second roller bearing 242 is fitted, and a flange portion 17b protruding inward in a radial direction from an outer peripheral portion on the rear end side of the recess 17a, and the above-described resin collar 46b is sandwiched between the flange portion 17b and the outer ring 242a of the second roller bearing 242. As a result, the movement of the second roller bearing 242 to the rear side is prevented, and the axial movement of the drive shaft 22 to the rear side is restricted by the second roller bearing 242 engaged via the pinion gear 22a.

An inner ring 242b of the second roller bearing 242 accommodated in the support portion 17 and the pinion gear 22a are directly connected. The second roller bearing 242 biases the drive shaft 22 to the front side (the side where the first roller bearing 241 is present), that is, to the rod tip side along the axial direction of the spool shaft 30. The first holding plate 52 provided ahead of the pinion gear suppresses the uplift of the pinion gear 22a to the upper side (front side) in the axial direction. In addition, due to the presence of the gap 29 between the outer ring 241a of the first roller bearing 241 and the reel main body 12a, the force by which the first holding plate 52 biases the outer ring 241a of the first roller bearing 241 escapes to the pinion gear 22a and the second roller bearing 242 via the inner ring 241b of the first roller bearing 241. That is, the outer ring 241a of the first roller bearing 241 disposed on the front side is not in contact with the reel main body 12a, and tolerance can be provided in the pinion gear axial direction. The inner ring 241b of the first roller bearing 241 is biased to the rear side, while the second roller bearing 242 disposed on the rear side biases the inner ring 242b forward while the outer ring 242a is locked to the reel main body 12a.

In the fishing spinning reel 6 formed in this manner, the first holding plate 52, the first roller bearing 241, the pinion gear 22a, and the second roller bearing 242 are integrally disposed along the axial direction of the spool shaft 30 in the drive shaft 22 and receive a force. In addition, since there is a gap between the outer ring 241a of the first roller bearing 241 and the reel main body 12a, the biasing force of the elastic member is not absorbed by the body, and effectively acts as the pressure applied to the roller bearing. Therefore, the minute forward and rearward movement of the drive shaft 22 caused by the rattle between the inner and outer rings of the first roller bearing 241 and the second roller bearing 242 that restrict the axial movement of the drive shaft 22 is absorbed. Furthermore, vibration of the rotor caused by a slight imbalance when the rotor 28 coupled to the drive shaft 22 is rotated is also integrally absorbed along the axial direction. Therefore, for example, it is possible to prevent discomfort from being given to the angler by preventing vibration caused by the first roller bearing 241, the second roller bearing 242, and the rotor 28 from being transmitted to the hand of an angler through the reel main body 12a during the winding operation, and extend the service life of the roller bearing by suppressing the rattling of the roller bearing.

The fishing spinning reel 6 according to an embodiment of the present invention comprises the operating part 16; the reel main body 12a; the drive shaft 22 that is rotatably supported on the front portion of the reel main body 12a via the first roller bearing 241 and is rotated in conjunction with the operating part 16; the rotor 28 that is attached to the drive shaft 22 and is rotated together with the drive shaft 22; and the spool 14 which the fishing line is wound by rotation of the operating part 16, in which the pinion gear 22a is provided on the drive shaft 22, and the elastic member 8 is provided on the front side of the pinion gear 22a in the axial direction of the drive shaft 22.

In this manner, it is possible to provide a fishing spinning reel capable of preventing uplift of the pinion gear and reducing occurrence of backlash by pushing down the pinion gear in an axially lower direction thereof in any state before the yarn winding, during the yarn winding operation, and after stopping the yarn winding. As described above, when a pinion gear tooth surface and a drive gear tooth surface come into contact with each other in a yarn winding forward direction, the pinion gear receives a force in the reverse direction, and thus, even in a case where there is a rattle in a pinion axis direction, the pinion gear is pressed in a pushing-down direction.

However, in a case where the input in a yarn winding direction is discontinuous or the yarn winding is stopped, a force for pushing down the pinion gear does not work, which causes uplift of the pinion gear accordingly. Even in a case where a spring washer is provided between the inner ring 242b of the second roller bearing 242 and the pinion gear 22a, such a state further occurs. However, by providing the elastic member described above and providing the gap 29 between the outer ring 241a of the first roller bearing 241 and the reel main body 12a, the pinion gear can be integrally pushed down in the axially lower direction, and the occurrence of backlash rattling can be prevented or reduced by preventing or reducing the uplift of the pinion gear. Therefore, it is possible to prevent or reduce the occurrence of unpleasant feelings for the operator due to the transmission of the backlash rattling through the handle to the winding side.

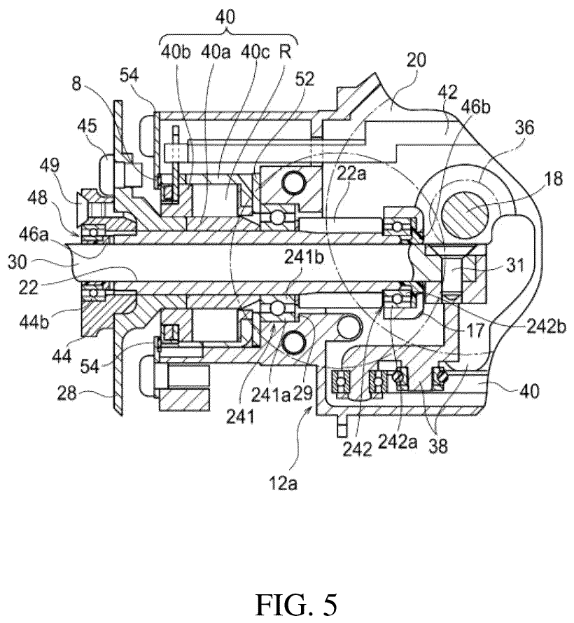

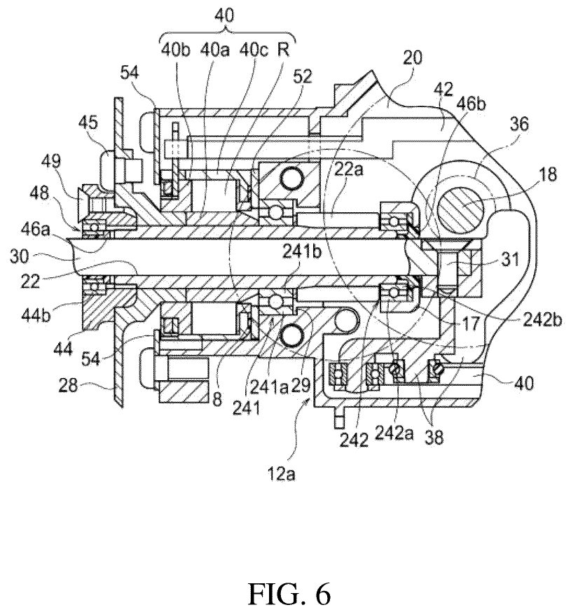

Next, the fishing spinning reel 6 according to an embodiment of the present invention will be described with reference to FIGS. 3, 4, 5, and 6. In the fishing spinning reel 6 according to an embodiment of the present invention, the first roller bearing 241 restricts the axial movement of the pinion gear 22a and the drive shaft 22 to the front side, the unidirectional clutch 40 is provided to the reel main body 12a via the second holding plate 54, the outer ring 40c of the unidirectional clutch 40 is connected to the outer ring 241a of the first roller bearing 241 via the first holding plate 52, and the elastic member 8 is provided between the first roller bearing 241 and the first holding plate 52 (example illustrated in FIGS. 3 and 4), between the outer ring 40c of the unidirectional clutch 40 and the first holding plate 52 (example illustrated in FIG. 6), or between the unidirectional clutch 40 and the second holding plate 54 (example illustrated in FIG. 5). Note that although not illustrated, it is also conceivable to provide the roller bearing between the unidirectional clutch 40 and the second holding plate 54. In this case, the elastic member 8 may be provided between the second holding plate 54 and the outer ring of the roller bearing.

With the fishing spinning reel 6 according to an embodiment of the present invention, it is possible to provide a fishing spinning reel capable of preventing uplift of the pinion gear and reducing occurrence of backlash by pushing down the pinion gear in an axially lower direction thereof in any state before the yarn winding, during the yarn winding operation, and after stopping the yarn winding. As described above, when a pinion gear tooth surface and a drive gear tooth surface come into contact with each other in a yarn winding forward direction, the pinion gear receives a force in the reverse direction, and thus, even in a case where there is a rattle in a pinion axis direction, the pinion gear is pressed in a pushing-down direction. However, in a case where the input in a yarn winding direction is discontinuous or the yarn winding is stopped, a force for pushing down the pinion gear does not work, which causes uplift of the pinion gear accordingly. Even in a case where a spring washer is provided between the inner ring of the second roller bearing 242 and the pinion gear 22a, such a state further occurs. However, by providing the elastic member described above, the pinion gear can be pushed down in the axially lower direction, and the occurrence of backlash rattling can be prevented or reduced by preventing or reducing the uplift of the pinion gear. Therefore, it is possible to prevent or reduce the occurrence of unpleasant feelings for the operator due to the transmission of the backlash rattling through the handle to the winding side.

In the fishing spinning reel 6 according to an embodiment of the present invention, the elastic member 8 biases the outer ring 241a of the first roller bearing 241 to the rear side in the axial direction of the drive shaft 22. However, by the elastic member 8 biasing the first roller bearing 241 to the rear side in the axial direction (side of the second roller bearing 242 opposite to a side where the first roller bearing 241 is present), the pinion gear can be pushed down in the axially lower direction, and the occurrence of backlash rattling can be prevented or reduced by preventing or reducing the uplift of the pinion gear.

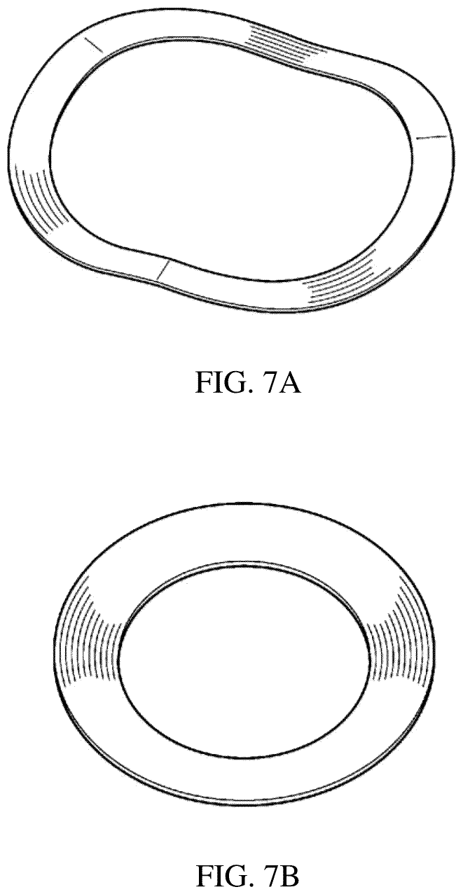

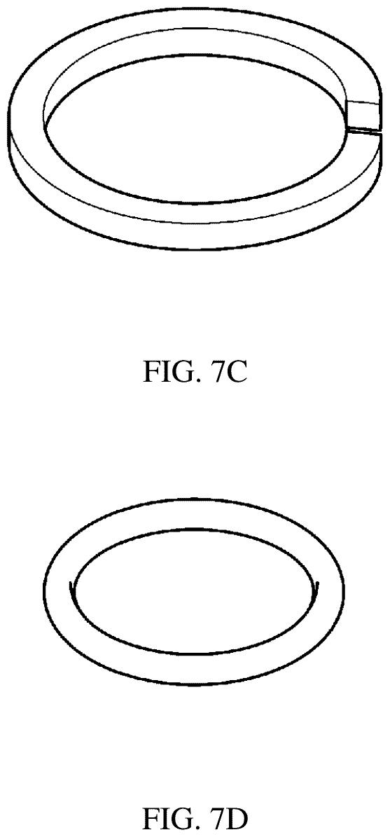

Next, as illustrated in FIG. 7, in the fishing spinning reel 6 according to an embodiment of the present invention, the elastic member 8 is any of a wave washer, a spring washer, a disc spring washer, or an O-ring.

The fishing rod 1 according to an embodiment of the present invention comprises the fishing spinning reel according to any one of above-description; and a rod body 2. In this manner, it is possible to provide a fishing rod comprising a fishing spinning reel capable of preventing uplift of the pinion gear and reducing occurrence of backlash by pushing down the pinion gear in an axially lower direction thereof in any state before the yarn winding, during the yarn winding operation, and after stopping the yarn winding.

Dimensions, materials, and arrangement of the components described in the present specification are not limited to those explicitly described in the embodiments, and these components may be modified to have optional dimensions, materials, and arrangement that might fall within the scope of the present invention. Components not explicitly described in the present specification can also be added to the described embodiment, or some of the components described in the embodiment can be omitted.

### REFERENCE SIGNS LIST

1 fishing rod
6 reel
8 elastic member
12a reel main body
12b leg portion
14 spool
16 operating part (handle)
18 handle shaft
20 drive gear
22a pinion gear
22 drive shaft
241 first roller bearing
241a outer ring of first roller bearing
242b inner ring of first roller bearing
242 second roller bearing
242a outer ring of second roller bearing
242b inner ring of second roller bearing
26 bail
27 fishing line guide portion
28 rotor
29 gap
30 spool shaft
40 unidirectional clutch
40a inner ring
40b retainer
40c outer ring
50 washer
52 first holding plate
54 second holding plate

1. A fishing spinning reel comprising:
an operating part;
a reel main body;
a drive shaft that is rotatably supported on a front portion of the reel main body via a roller bearing and is rotated in conjunction with the operating part;
a rotor that is attached to the drive shaft and is rotated together with the drive shaft; and
a spool around which a fishing line is wound by rotation of the operating part, wherein
a pinion gear is provided on the drive shaft, and
an elastic member is provided on a front side of the pinion gear in an axial direction of the drive shaft.

2. The fishing spinning reel according to claim 1, wherein a rear side of an outer ring of the roller bearing as viewed in the axial direction of the drive shaft is not in contact with the reel main body.

3. The fishing spinning reel according to claim 1, wherein
the roller bearing restricts an axial movement of the pinion gear and the drive shaft to a front side,
the elastic member is provided between the roller bearing and a washer,
an outer ring of the roller bearing is attached to the reel main body, and
a rear side of the outer ring of the roller bearing as viewed in the axial direction of the drive shaft is not in contact with the reel main body.

4. The fishing spinning reel according to claim 1, wherein
the roller bearing restricts an axial movement of the pinion gear and the drive shaft to a front side,
the elastic member is provided between an outer ring of a unidirectional clutch and a washer,
an outer ring of the roller bearing is attached to the reel main body, and
a rear side of the outer ring of the roller bearing as viewed in the axial direction of the drive shaft is not in contact with the reel main body.

5. The fishing spinning reel according to claim 1, wherein
the roller bearing restricts an axial movement of the pinion gear and the drive shaft to a front side,
the elastic member is provided between a unidirectional clutch and a second holding plate,
an outer ring of the roller bearing is attached to the reel main body, and
a rear side of the outer ring of the roller bearing as viewed in the axial direction of the drive shaft is not in contact with the reel main body.

6. The fishing spinning reel according to claim 1, wherein
the roller bearing restricts an axial movement of the pinion gear and the drive shaft to a front side,
a unidirectional clutch is provided to the reel main body via a second holding plate,
an outer ring of the unidirectional clutch is connected to an outer ring of the roller bearing via a washer, and
an elastic member is provided between the roller bearing and the washer, between the outer ring of the unidirectional clutch and the washer, or between the unidirectional clutch and the second holding plate.

7. The fishing spinning reel according to claim 1, wherein the elastic member biases an outer ring of the roller bearing to a rear side in the axial direction of the drive shaft.

8. The fishing spinning reel according to claim 1, wherein the elastic member is any of a wave washer, a spring washer, a disc spring washer, or an O-ring.

9. A fishing rod comprising;
the fishing spinning reel according to claim 1; and
a rod body.
